(19) United States
(12) Patent Application Publication
(10) Pub. No.: US 2026/0057678 A1
(43) Pub. Date: Feb. 26, 2026

(54) SYSTEM

(71) Applicant: SOFTBANK GROUP CORP., Tokyo (JP)

(72) Inventor: Mitsuo KOI, Tokyo (JP)

(73) Assignee: SOFTBANK GROUP CORP., Tokyo (JP)

(21) Appl. No.: 19/302,354

(22) Filed: Aug. 18, 2025

(30) Foreign Application Priority Data
Aug. 22, 2024 (JP) 2024-141299

(51) Int. Cl. G06V 20/54; G06V 20/40; G06V 40/10

(52) U.S. Cl. CPC G06V 20/54; G06V 20/40; G06V 40/10; G06V 2201/08

(57) ABSTRACT

A system includes a processor that acquires real-time video of an intersection, analyzes the acquired video to detect vehicles and pedestrians passing through the intersection, determines a traffic volume based on the detection result, changes a traffic signal when the traffic volume is determined to be below a predetermined threshold, and confirms a state of the traffic signal after the change.

### CROSS-REFERENCE TO RELATED APPLICATION

This application is based on and claims priority under 35 USC 119 from Japanese Patent Application No. 2024-141299 filed on Aug. 22, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional traffic signal control systems, the timing of signal changes at intersections is typically based on fixed schedules or simple sensor inputs. Such methods often result in inefficient traffic flow, unnecessary waiting times, and do not respond effectively to real-time fluctuations in traffic volume, especially during off-peak hours or night-time. There is a need for a traffic signal control system that can dynamically and efficiently adjust signal changes based on real-time intersection conditions.

### SUMMARY

To solve these problems, the present invention provides a system including a processor that acquires real-time video of an intersection, analyzes the acquired video to detect vehicles and pedestrians, determines traffic volume based on the detection result, and changes the traffic signal when the traffic volume is below a predetermined threshold. The processor further confirms the state of the signal after the change, and may also acquire the current state of the signal and record the changed state in a log. This enables automated, real-time, and efficient control of traffic signals in accordance with actual intersection conditions.

“Processor” means a hardware or software component capable of executing instructions, performing computations, and controlling various processes within the system.

“Real-time video” means image data is captured and transmitted with minimal delay, allowing immediate processing and analysis of the observed scene.

“Intersection” means a location where two or more roads cross or meet, and where vehicular and/or pedestrian traffic flows are controlled by traffic signals.

“Analyze” means to process and examine image data in order to identify and extract relevant information, such as the presence and characteristics of objects within the video.

“Vehicles” means cars, trucks, motorcycles, buses, or any other modes of transportation that travel on roads.

“Pedestrians” means persons walking or otherwise moving on foot through or near an intersection.

“Detect” means to identify the existence, position, and attributes of vehicles and pedestrians within the acquired video.

“Traffic volume” means the estimated or measured quantity of vehicles and/or pedestrians passing through an intersection within a specific period of time.

“Predetermined threshold” means a set value of traffic volume, used as a reference criterion for deciding whether to change the traffic signal.

“Change” means to alter the state of the traffic signal, such as switching from red to green or vice versa.

“Traffic signal” means a device or apparatus for controlling vehicles and pedestrian movement at an intersection, typically by displaying colored lights such as red, yellow, and green.

“Confirm” means to verify whether a specific action, such as a signal change, has been executed successfully.

“Log” means a recorded file or database entry containing information related to events, actions, or states within the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or”is employed to link three or more items in the present specification.

### First Exemplary Embodiment

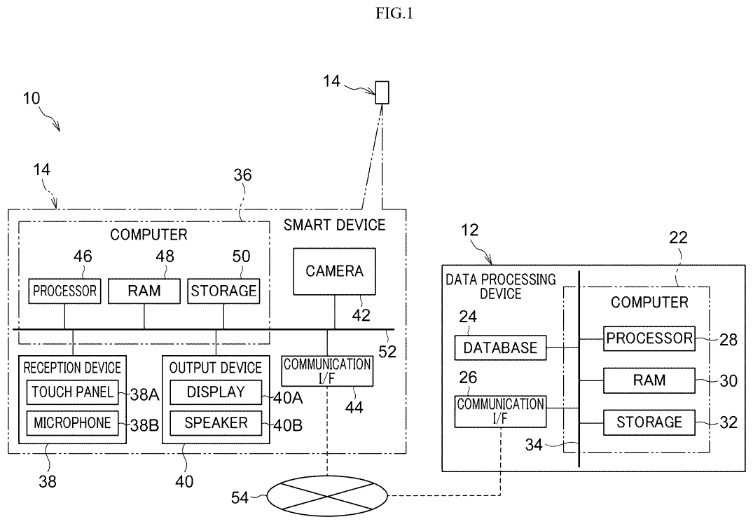

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

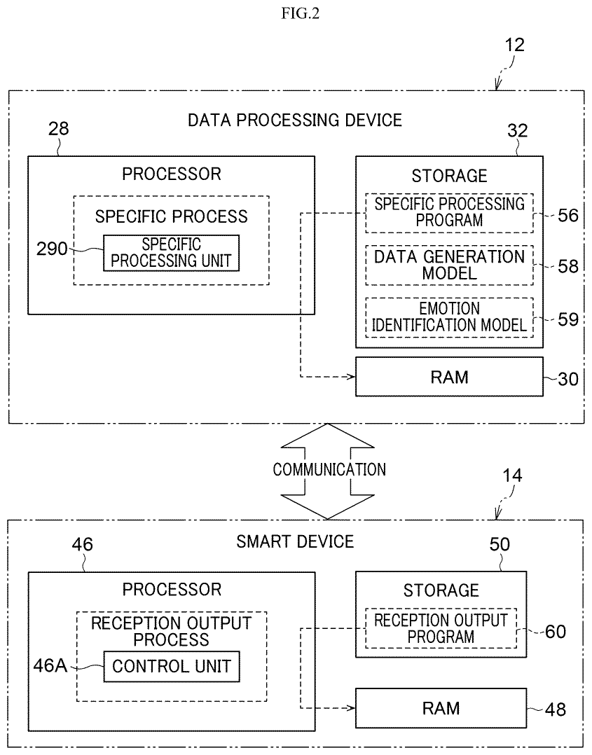

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program”according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional intersection control systems, traffic signals are often switched at fixed intervals without considering real-time variations in traffic flow. This can lead to unnecessary delays and congestion, as the system cannot flexibly respond to changes in the number of vehicles or pedestrians, especially during off-peak hours or nighttime. Furthermore, such traditional systems generally lack comprehensive logging, making it difficult to analyze and optimize traffic control based on actual traffic conditions.

The specific processing by the specific processing unit 290 of the data processing device 12 in Example 1 is realized by the following means.

The present invention provides a server including a processor configured to acquire real-time environmental information from a monitoring device, analyze the information to detect moving objects, extract attribute and motion information using an image processing device, determine traffic volume based on the extracted information, transmit a control signal to a traffic control device to change the state when the volume falls below a threshold, verify the state change, and record process and result data in an information management device. This enables highly responsive and flexible traffic signal control according to actual conditions, as well as detailed logging and analysis for subsequent system improvement.

The term “environmental information” refers to data representing the conditions of a monitored area, including video streams, images, sensor data, or other relevant signals, which are obtained in real time from a monitoring device such as a camera.

The term “monitoring device” refers to an apparatus installed in or around an area of interest, such as an intersection, that is configured to capture or collect environmental information, including but not limited to cameras, image sensors, or other types of environmental sensors.

The term “moving object” refers to a physical entity, such as a vehicle or pedestrian, that exhibits motion and is present within the monitored area, as detected from the environmental information.

The term “image processing device” refers to a hardware or software component that analyzes environmental information and extracts features, attributes, and motion data of a moving object.

The term “attribute information” refers to characteristic data relating to a moving object, such as object type, category, size, or classification.

The term “motion information” refers to data representing the dynamics of a moving object, including its position, speed, movement direction, or trajectory within the monitored area.

The term “predetermined region” refers to a spatial area defined in advance within the monitored environment, such as a lane or crosswalk, for the purpose of detecting or counting moving objects.

The term “traffic volume” refers to the calculated number of moving objects passing through or present within a predetermined region during a specific time interval.

The term “control signal” refers to an electronic or digital instruction transmitted from the processor to a traffic control device to command or configure the state of a control target.

The term “traffic control device” refers to a system or apparatus responsible for managing and controlling the state of a control target, such as a signal controller for regulating traffic lights at an intersection.

The term “control target” refers to an object or component, such as a traffic signal, whose operating state is managed or adjusted as part of the system's operation.

The term “information management device” refers to a hardware or software system configured to record, store, or manage process and result data, including logs of system activity, state changes, and decision reasons.

The term “information recording device” refers to any system or apparatus that persistently stores information, such as state changes, logs, or reasons for decisions, which may be retrieved or analyzed at a later time.

The server is equipped with a processor, memory, and communication interfaces and is configured to receive environmental information from a monitoring device such as a high-definition network camera installed at an intersection. In a typical embodiment, hardware includes a general-purpose computation device designed for edge or data center processing, and the monitoring device may be a digital imaging device suitable for environmental sensing.

The server utilizes preinstalled software libraries for network communication, image processing, and machine learning inference. Common software platforms include operating systems such as Linux, computer vision libraries such as OpenCV, and deep learning frameworks including TensorFlow or PyTorch. For example, the server may run the YOLOv5 deep learning model using PyTorch for the detection of moving objects such as vehicles and pedestrians. The server further uses communication frameworks such as MQTT to interact with traffic control devices, which may be standard digital controllers responsible for signal lights or other control targets at the intersection.

The server initiates the acquisition of real-time video or image data from the monitoring device via a secured communication channel (for example, HTTP or RTSP). Upon receiving environmental information, the server executes image processing techniques to extract features, such as motion vectors and object classification probabilities, and to assign attributes, including object type and estimated trajectory, to detected moving objects. The server continually maintains a summary of the number of moving objects present or moving through a predetermined region within the monitored area, for example, a crossing or vehicle lane, and evaluates traffic volume based on this count.

When the calculated traffic volume falls below a specified threshold, the server generates and transmits a control signal to the traffic control device using the standardized communication protocol (for example, MQTT). The control signal can cause a change in the operating state of a control target, such as switching a traffic light from red to green. Thereafter, the server acquires updated state information from the control target, verifying that the instructed change has occurred, and subsequently records process details, state transitions, and pertinent metadata such as timestamps and the server's judgment data to an information management device. Software for data management may include logging and analytics solutions, such as the Elastic Stack, for persistent storage and later retrieval.

In certain configurations, terminals can be provided for users, such as operators, to receive state notifications from the server over network protocols. The terminal displays the updated states or logs, and the user can monitor and verify the operation of the system for traffic analysis, auditing, or public reporting.

A practical example is as follows: The server receives a video stream from a monitoring device at night, processes the stream with YOLOv5 using an edge-computing processor, and identifies that no vehicles or pedestrians are present. The server determines that the traffic volume is low and instructs the control target to change the traffic signal to green, verifying the change and recording all relevant information. The terminal then displays this state for user confirmation. All of these operations proceed automatically, requiring no periodic manual intervention by the user.

An example of a prompt sentence for a generative AI model is as follows:

“Please explain a concrete implementation of a system that analyzes live video from intersection cameras and efficiently controls traffic signals at night when traffic volume is low. Please also include details regarding the hardware (such as a general-purpose computation device and a high-definition network camera) and software (such as a deep learning framework and a logging system) used in the system.”

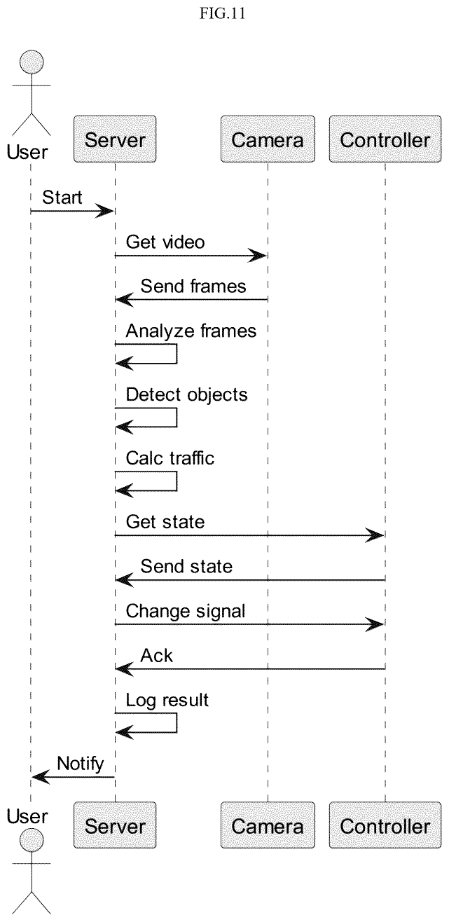

The following describes the processing flow using FIG. 11.

### Step 1:

The server acquires real-time environmental information by connecting to the monitoring device, which is typically a network camera installed at an intersection. The input is a live video stream or series of image frames received via a network protocol such as RTSP or HTTP. The server periodically requests and receives image frames, converting the data into an appropriate format for processing. The output is a continuous sequence of raw image frames buffered in the server's memory.

### Step 2:

The server stores the received image frames in a buffer allocated in memory. The input is the raw image frames from Step 1. The server manages this buffer to maintain the most recent several seconds of video data, discarding the oldest frames as new ones arrive. The output is a managed buffer of the most recent image frames, ready for analysis.

### Step 3:

The server analyzes each buffered image frame using an image processing device, typically employing a deep learning model such as YOLOv5 running on a framework like PyTorch or TensorFlow. The input is an individual image frame from the memory buffer. The server performs object detection and classification to identify moving objects, such as vehicles or pedestrians, and extracts attribute information (e.g., object type) and motion information (e.g., position, direction, speed). The output is a list of detected moving objects in each frame, including their extracted features.

### Step 4:

The server computes the traffic volume within a predetermined region by aggregating the detection results over a defined period (for example, the last 10 seconds). The input is the time series data of detected objects and their features from Step 3. The server counts the number of unique moving objects that pass through or remain within the specific region, based on their position and motion trajectories. The output is a calculated value of traffic volume for the current time window.

### Step 5:

The server determines whether the computed traffic volume falls below a specified threshold. The input is the traffic volume value from Step 4 and the pre-configured threshold value. The server compares these values and makes a logical decision about traffic conditions. The output is a Boolean indicator or a decision variable signaling whether action is required.

### Step 6:

If the indicator from Step 5 reveals that the traffic volume is below the threshold, the server initiates a control action. The input is the Boolean decision variable from Step 5. The server constructs and transmits a control signal, such as a state change command, to the traffic control device (e.g., a signal controller) using a network communication protocol like MQTT. The output is the submission of a digital instruction to the traffic control device.

### Step 7:

The server verifies the state change of the control target by requesting and receiving the current state from the traffic control device. The input is a status request sent to the device and the corresponding state information returned. The server checks whether the received state matches the intended new state. The output is a confirmation result indicating success or failure of the state change.

### Step 8::

The server documents all relevant information about the process, including the input and output of each stage, the time of execution, the server's decisions, and the confirmed results. The input comprises event data such as detection statistics, control actions, and device responses generated during Steps 1-7. The server writes structured logs or records into an information management device, such as a data storage system. The output is a persistent log available for later retrieval, monitoring, or auditing by terminals or users.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional traffic signal control systems deployed at intersections, it is difficult to accurately and efficiently control signals in real time based on actual road usage and user states. Existing systems typically lack the capability to sense and analyze the number and types of mobile bodies and pedestrians currently present or to consider the emotional states of users in the vicinity. As a result, traffic flow becomes suboptimal, and the risk of congestion or accidents increases. Moreover, there is insufficient integration with autonomous vehicles and inadequate adaptation to real-world conditions such as sudden changes in pedestrian urgency or emotion, leading to decreased safety and efficiency.

The specific processing by the specific processing unit 290 of the data processing device 12 in Application Example 1 is realized by the following means.

The present invention provides a server including a processor configured to acquire real-time image information from motion information acquisition devices, analyze the images using image processing techniques and recognition models to determine the number and attributes of target objects, evaluate traffic volume, control signal state on the basis of traffic and emotional states detected by an emotion recognition model from biosignal acquisition devices, confirm signal state changes, log operational results, provide real-time signal and traffic information to mobile devices, and optimize mobile device behavior. This enables highly adaptive and intelligent intersection signal control systems that dynamically respond to both real-time traffic conditions and user emotions, improving traffic flow and safety while supporting integration with autonomous vehicles.

The term “processor” refers to a computing component or assembly configured to execute instructions, process data, and control the operation of a system in accordance with programmed logic.

The term “image information” refers to digital data representing visual content captured by an image acquisition device, such as still images or video streams depicting a physical space.

The term “motion information acquisition device” refers to any sensor, camera, or electronic equipment capable of capturing real-time data related to movement, appearance, or activity within a monitored area.

The term “image processing technology” refers to computational techniques and algorithms applied to digital images in order to extract, enhance, or transform information present in the image data.

The term “recognition model” refers to a mathematical or algorithmic structure, often based on machine learning or neural networks, trained to identify and classify objects or features within data such as images.

The term “target objects” refers to entities, including mobile bodies, pedestrians, vehicles, or other relevant items, which are subject to identification and analysis within an image.

The term “attribute information” refers to descriptive data about target objects, such as type, location, quantity, or movement characteristics.

The term “traffic volume” refers to the quantified measure of the number of mobile bodies or pedestrians passing through or present in a specific area during a determined time period.

The term “signal control device” refers to an apparatus or interface configured to manage or alter the state of traffic signals at an intersection.

The term “state information” refers to data indicating the current operational condition or status of a system component, such as the color or mode of a traffic signal.

The term “storage device” refers to any device, medium, or memory component capable of retaining digital data for subsequent access and processing.

The term “communication function” refers to the capability of sending, receiving, or exchanging data and messages between components or systems via wired or wireless networks.

The term “mobile device” refers to any vehicle, robotic platform, or portable apparatus capable of movement and communication with a server or system.

The term “biosignal acquisition device” refers to a sensor or instrument that measures physiological signals or biometric data, such as facial expressions or other emotional indicators, from a user.

The term “emotion information” refers to data representing or derived from the physiological or behavioral state of a user, associated with emotional conditions such as calmness, frustration, or impatience.

The term “emotion recognition model” refers to a computational or algorithmic structure, typically employing statistical analysis or machine learning, that estimates the emotional state of a user based on biosignal data.

The term “recording medium” refers to any physical or electronic medium capable of storing information, such as hard drives, solid-state memory, or cloud-based storage.

The invention may be implemented as a system including a server equipped with a processor, a storage device, and communication functions, as well as one or more motion information acquisition devices such as cameras, biosignal acquisition devices such as emotion sensors, signal control devices, and mobile devices such as vehicles.

The server serves as the core component of the system. The server is equipped with a general-purpose processor (for example, a CPU or GPU) capable of executing various software modules. The server may operate on commercially available hardware platforms and a standard operating system such as Linux or Windows. Preferably, the server is connected to the other devices via standard communication networks, such as Local Area Networks (LAN), wireless LAN, or dedicated communication lines.

The image information of the target area, such as an intersection, is acquired in real time by motion information acquisition devices such as IP cameras or surveillance cameras, which are positioned to monitor the relevant area. The emotion information associated with nearby users is acquired in real time by biosignal acquisition devices, including but not limited to, facial expression recognition cameras or wearable sensors.

The server receives image information and emotion information through its communication interfaces and temporarily stores the data in its storage device (e.g., hard disk drive, solid-state drive, or memory). The server processes the image information using an image processing technology, such as OpenCV, and applies a recognition model, for example, a neural network-based object detection model (such as YOLOv4), to identify vehicles, pedestrians, bicycles, or other relevant target objects. From this processing, the server extracts attribute information such as the type, number, location, and movement direction of each detected object.

The server further acquires biosignal data and analyzes it using an emotion recognition model, such as DeepFace or a similar deep learning-based emotion classifier, to estimate the emotional state of one or more users present in the monitored area. Information such as calmness, frustration, or impatience can be derived from the facial expressions or other biometric signals of users.

Based on the results of these analyses, the server evaluates the traffic volume by counting the number of identified vehicles and pedestrians. It also monitors the emotional states of users. When the traffic volume falls below a preset threshold or if users are determined to be in a particular emotional state (for example, impatience or frustration), the server determines whether to alter the timing or state of the traffic control device (for example, to switch a traffic signal from red to green).

The server communicates with the signal control device using standard protocols (such as HTTP, TCP, or serial communication), sends commands to change the signal status, and confirms the actual status changes by reading responses from the signal control device. The server then logs all signal changes, decision information, traffic volume values, and user emotional states in its storage device or a related recording medium.

Furthermore, the server serves as a central node for transmitting signal and traffic status information to mobile devices, such as autonomous vehicles. This is realized using a standard message protocol, such as MQTT or HTTP. By receiving such information, the mobile device may optimize its travel route or driving behavior in anticipation of future signal changes and current traffic conditions.

For example, during nighttime, the server may detect a lower number of vehicles and pedestrians and, upon evaluating a user's emotional state as “impatient,” may decide to advance the traffic light change. In another example, the server identifies a queue of vehicles and signals the autonomous vehicles approaching the intersection to optimize their stop-and-go behavior before the light turns green.

The overall system architecture is modular and can be implemented using existing hardware components and publicly available software libraries.

Below is a prompt sentence example for a generative AI model, intended to produce part of a suitable source code for the above system:

“Please generate the missing part of the following Python program, where the server analyzes camera images from an intersection using an object detection model, detects vehicles and pedestrians, estimates user emotion using an emotion recognition model, evaluates traffic volume and emotional state, and issues a command to change the signal if required. The system should also broadcast the new signal state to mobile devices using MQTT.”

This implementation ensures that the invention may be readily practiced using widely available technologies and provides a foundation for further enhancements or integrations with various types of mobile or biosignal acquisition devices.

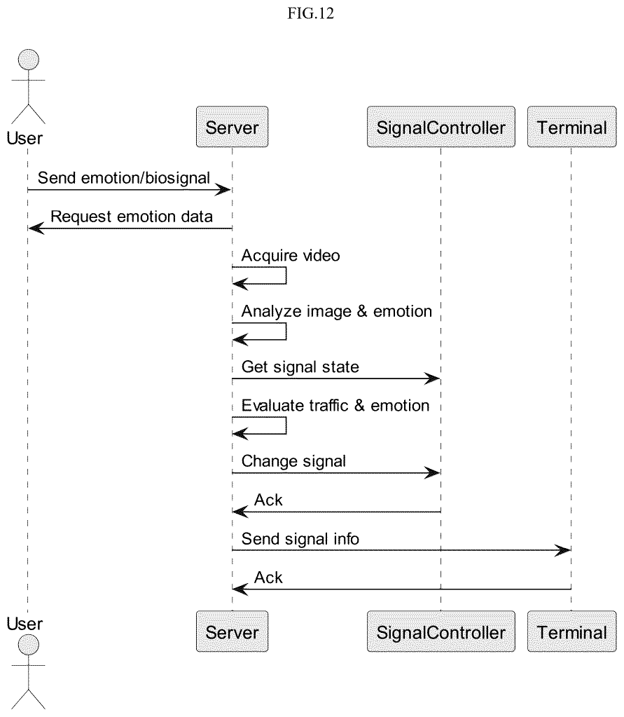

The following describes the processing flow using FIG. 12.

### Step 1:

The server acquires real-time image data from one or more motion information acquisition devices, such as network cameras, and obtains emotion data from biosignal acquisition devices, such as emotion sensors or face recognition cameras.

Input: Real-time video stream (e.g., RTSP stream) and biosignal data (e.g., face images or physiological sensor data).

Processing: The server sends requests to corresponding devices, receives image frames and biosignal input, and saves them temporarily in local memory.

Output: Sets of raw image frames and biosignal data stored in the server's memory or storage.

### Step 2:

The server processes the acquired image data using an image processing library, such as OpenCV, and applies an object detection recognition model, such as YOLOv4, to detect and identify all vehicles, pedestrians, and other relevant objects in the monitored area.

Input: Image frames obtained from the previous step.

Processing: The server decodes each image frame, passes the frames through the trained neural network model, and extracts the type, location, count, and movement direction of detected objects.

Output: A structured list of target objects with their attributes (e.g., class, position, direction).

### Step 3:

The server analyzes the emotion data acquired from biosignal acquisition devices using an emotion recognition model, such as DeepFace, to estimate the emotional state of users present at the intersection.

Input: Face images or biosensor data collected in Step 1.

Processing: The server passes the input through the emotion recognition model, classifies each user's emotional state (e.g., calm, impatient, frustrated), and associates this information with location or object records.

Output: A list of users and their estimated emotional states.

### Step 4:

The server evaluates the traffic volume and emotional state to determine the current situation at the intersection.

Input: List of detected objects from Step 2 (with associated counts and attributes) and list of user emotion states from Step 3.

Processing: The server counts the number of mobile bodies and pedestrians, compares the total to a preset threshold, and checks for the presence of specific emotional states such as impatience or frustration.

Output: A decision variable indicating whether to change the traffic signal and detailed reasoning for the decision.

### Step 5:

The server interacts with the signal control device to obtain the current state of the intersection signal, and determines, based on the evaluation from the previous step, whether a change in the signal is necessary.

Input: The evaluation results from Step 4 and the current signal state obtained from the signal control device.

Processing: The server sends a status request to the controller, receives the current color (e.g., red or green), and checks if the signal meets current optimal conditions. If not, the server prepares to issue a change command.

Output: A command decision specifying whether to change the signal and the desired new state.

### Step 6:

The server issues a command to the signal control device to change the state of the traffic light and waits for confirmation of the action.

Input: Decision to change the signal and target signal state from Step 5.

Processing: The server transmits a command (e.g., via API, TCP, or serial) to instruct the device to change to the specified signal state, such as from red to green, and waits for the controller's acknowledgment.

Output: Signal control action completion and updated signal state information.

### Step 7:

The server verifies the change in the signal state by querying the signal control device, and ensures the transition has occurred as commanded.

Input: Confirmation or status message from the signal control device.

Processing: The server compares the reported signal state to the requested state and validates successful execution.

Output: Verification result indicating correspondence between command and signal status.

### Step 8:

The server records the entire decision process, including traffic evaluation, emotion states, signal changes, and timestamps, in a storage device for later analysis or audit.

Input: All relevant variables from the previous steps, including detected objects, emotional states, decision reasoning, signal commands, and final status.

Processing: The server creates structured log entries detailing each step of the operational sequence, decision logic, and final outcomes.

Output: Persistent log entries in a file system or dedicated recording medium.

### Step 9:

The server communicates the updated signal state and contextual information (e.g., traffic count, emotional status) to mobile devices, such as autonomous vehicles, using a network communication function (such as MQTT, HTTP, or similar protocols).

Input: Latest signal state, traffic count, and emotional context.

Processing: The server formats the collected information and sends it to registered mobile devices via the selected protocol.

Output: Delivery of real-time signal and context data to mobile devices.

### Step 10:

The terminal (for example, an autonomous vehicle) receives the traffic signal and contextual information from the server and adapts its travel behavior or route accordingly.

Input: Signal state and contextual information received from the server in Step 9.

Processing: The terminal interprets the message, updates its operation strategy (such as decelerating, accelerating, or changing route), and optimizes travel through the intersection.

Output: Modified driving behavior or routing by the terminal, enhancing safety and efficiency for the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional control systems for devices such as traffic signals are based primarily on evaluating traffic volume, but cannot account for real-time, dynamic changes in the emotional state of people at a location, such as anxiety or frustration at an intersection. As a result, these systems often fail to achieve optimal control responsive to sudden changes in traffic flow and user behavior, leading to inefficiencies and reduced safety or user satisfaction.

The specific processing by the specific processing unit 290 of the data processing device 12 in Example 2 is realized by the following means.

The present invention provides a server including a processor configured to acquire spatial information in real time from an image information acquisition device, analyze the acquired spatial information to detect moving objects, analyze emotion state information from a biometric information acquisition device associated with the detected moving objects and identify emotion states, determine traffic conditions and emotion states based on the number of detected moving objects and the emotion state information, change the state of a controlled device when the traffic condition is determined to be below a predetermined threshold or when the emotion state is determined to be a predetermined state, and confirm the state of the controlled device after the change. This enables optimal, flexible control of a controlled device such as a traffic signal, not only on the basis of traffic volume or object detection, but also in response to the real-time emotional state of users or people present at a relevant location.

The term “processor” refers to any computing unit or circuit, including but not limited to a central processing unit (CPU), graphics processing unit (GPU), microcontroller, or any system-on-chip, that is capable of executing computer-executable instructions to perform programmed operations.

The term “spatial information” refers to data representing physical attributes, locations, or arrangements of objects or regions in a specified environment, such as coordinates, images, or video data that capture the position and movement of entities.

The term “image information acquisition device” refers to any apparatus or component capable of capturing or generating image or video data, including cameras, video recorders, or other optical sensors.

The term “moving object” refers to any entity within the acquired spatial information that exhibits displacement or change in position over time, such as a vehicle, pedestrian, animal, or other mobile subject.

The term “biometric information acquisition device” refers to any apparatus or sensor capable of acquiring data related to biological features or physiological attributes of a subject, including facial expression sensors, voice sensors, or other emotion recognition sensors.

The term “emotion state information” refers to data generated or derived from biometric sources that indicates or estimates the emotional status of a person, such as anxiety, joy, anger, or similar mental conditions.

The term “controlled device” refers to any target hardware, apparatus, or system whose operational state can be changed or modulated through external commands, such as a traffic signal unit or other automation device.

The term “storage area” refers to any physical or logical location where data can be saved, retained, or archived, including volatile or non-volatile memory, disk drives, databases, or cloud storage resources.

The server, as the main processing unit of the system, is configured to coordinate and control the acquisition, analysis, and utilization of spatial and emotion state information for dynamic control of a controlled device, such as a traffic signal. The server may be a general-purpose computer or a dedicated processing apparatus equipped with sufficient computational resources: for example, central processing units (CPUs), memory, storage, and network interfaces that enable real-time communication and data exchange with terminals.

The terminal, located at a spatial point such as an intersection, is equipped with an image information acquisition device and a biometric information acquisition device. The image information acquisition device may be a digital camera or similar optical sensor capable of providing real-time image or video data. The biometric information acquisition device may take the form of a facial emotion sensor or other biometric sensor capable of generating emotion state information from one or more individuals present in the area.

The server is programmed to receive and aggregate spatial information (such as image files or video frames) from the image information acquisition device at regular intervals, such as every five seconds. The server uses software modules such as an object detection model implemented by a deep learning framework (for instance, frameworks like PyTorch, with models such as YOLOv5) to detect moving objects—specifically, vehicles or pedestrians—in the incoming spatial information. At the same time, the server acquires emotion state information from the biometric information acquisition device and processes it using an emotion analysis module, for example based on a cloud API for facial emotion detection.

The server associates detected moving objects with corresponding emotion state data based on factors such as position, timing, or unique identifiers. The server then evaluates the number of detected moving objects as well as the emotion states of individuals, for example determining whether the number of detected vehicles or pedestrians is below a preset threshold, or whether a significant number of detected individuals are experiencing emotions such as anxiety or frustration. According to these evaluations, the server dynamically determines whether to change the state of the controlled device, such as switching the color of a traffic light. The change command is transmitted to the control interface of the controlled device over a network.

The terminal, functioning as a controlled device, receives the instruction from the server and executes the change—for example, illuminating a traffic light signal in a new state. The terminal may send feedback regarding the current status of the controlled device back to the server, enabling the server to confirm successful execution. The server records the control history, including the timing, condition, and reason for each change, in a storage area such as a database or persistent file system for later retrieval and analysis.

For concrete implementation, hardware such as IP cameras or industrial control components can be used, and the various modules may run on servers with modern operating systems. Typical software includes computer vision libraries like OpenCV, deep learning models for object detection, and emotion recognition APIs.

As a specific example, during daytime operation at an intersection, the server receives a JPEG image from the camera every five seconds, detects a group of pedestrians, and, upon recognizing that several of them exhibit anxious emotion states, proactively changes the traffic signal to green to ease congestion and improve pedestrian satisfaction. The server logs this decision with details such as “change time: 14:35, type: red to green, reason: pedestrian anxiety detected”.

Example prompt sentences for use with a generative AI model include:

“Design an algorithm that acquires data from cameras and emotion recognition sensors at an intersection during the day, and changes the traffic signal optimally based on both traffic volume and user emotions.”

“Draw a flowchart for a system that analyzes the number and emotions of vehicles and pedestrians at a crosswalk in real time, to implement efficient traffic signal control.”

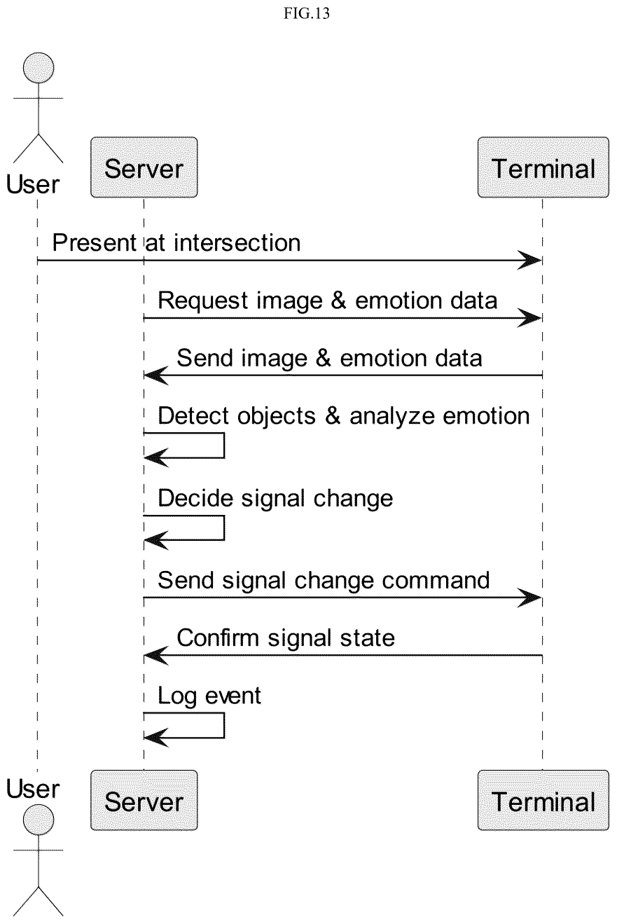

The following describes the processing flow using FIG. 13.

### Step 1:

The server initiates a periodic request to the terminal (the camera and the biometric sensor) to acquire real-time spatial information and emotion state information.

Input: Scheduled trigger on the server; network addresses of image information acquisition device and biometric information acquisition device.

The terminal (the camera) captures a still image or video frame of the intersection and returns the image data (for example, JPEG format) to the server. The terminal (the biometric sensor) analyzes the real-time biometric data of people in the vicinity, detects emotion state information (such as anxiety or calmness), and returns this data (for example, JSON format) to the server.

Output: Image data and emotion state data, sent from the terminal to the server for further processing.

### Step 2:

The server receives the image data and emotion state data.

Input: Image data (e.g., JPEG) and emotion state data (e.g., JSON) from the terminal.

The server processes the image data using an object detection model (such as YOLOv5 with a deep learning library) to identify and locate moving objects, such as vehicles and pedestrians. The server decodes the JSON emotion data and extracts the emotional states assigned to detected individuals.

Output: A list of detected moving objects with their positions and a corresponding set of emotion states for identified individuals.

### Step 3:

The server analyzes and associates the spatial and emotion state information.

Input: List of detected moving objects and set of emotion states from Step 2.

The server matches each detected moving object with available emotion data based on spatial proximity (such as matching positions) and timestamp correlation. If possible, the server assigns each detected object an emotion state label (for example, “pedestrian 1:anxiety”).

Output: A summary dataset associating each moving object with its position, type, and emotional state.

### Step 4:

The server evaluates traffic and emotion conditions to decide whether the controlled device state requires change.

Input: Summary dataset of detected moving objects and their emotion states from Step 3; pre-defined thresholds for traffic and emotion states.

The server aggregates the number of vehicles and pedestrians detected within a defined time window (such as one minute) and calculates the proportion of individuals with designated emotion states (e.g., “anxiety” or “frustration”). The server compares these results against the pre-defined thresholds (such as number of vehicles <10; percentage of anxiety >30%).

Output: Determination of whether to change the controlled device state (e.g., traffic signal).

### Step 5:

The server sends a control command to the controlled device (e.g., traffic signal controller) when a condition for change is met.

Input: Decision result from Step 4 indicating required state change; address of the controlled device.

The server formats a network protocol message (for example, RESTful POST command) to instruct the controlled device to change state (such as switch signal from red to green). The terminal (the controlled device) receives the instruction and carries out the required physical operation, such as actuating the traffic signal relay.

Output: Confirmation message or change status from the controlled device to the server.

### Step 6:

The server confirms the controlled device state and records the control event.

Input: Status response from the controlled device following the change command.

The server checks if the controlled device has achieved the expected state. If confirmed, the server logs the event with metadata such as timestamp, device state, and reason for change (e.g., “Signal turned green due to high pedestrian anxiety and low vehicle traffic”).

Output: Log entry stored in the server's storage area for recordkeeping and future analysis.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional traffic signal control systems make decisions primarily based on traffic volume at intersections, without taking into account the emotional states of users such as drivers and pedestrians. As a result, these systems are unable to swiftly and appropriately respond to emergencies or situations where users experience stress, anxiety, or urgency. This limitation creates challenges in further optimizing traffic flow and improving safety and user satisfaction at intersections.

The specific processing by the specific processing unit 290 of the data processing device 12 in Application Example 2 is realized by the following means.

The present invention provides a server including a processor configured to acquire intersection image information in real time, analyze the acquired image information to detect moving objects passing through the intersection, determine a traffic volume at the intersection based on the detection result of the moving objects, acquire a user's emotional state, analyze the emotional state to determine whether the emotional state exceeds a predetermined threshold, change a traffic control signal when the traffic volume is less than or equal to a predetermined threshold or when the emotional state exceeds the predetermined threshold, confirm a state of the traffic control signal after the change, display the state of the changed traffic control signal and a reason for the change on an information presentation device, and record the state of the changed traffic control signal and the reason for the change. This enables flexible and responsive traffic signal control that takes both traffic conditions and user emotions into account, thereby optimizing traffic flow, improving safety, and enhancing user experience at intersections.

The term “processor” refers to an information processing unit or device capable of executing instructions to perform data processing, analysis, and control operations within the system.

The term “intersection image information” refers to real-time visual data acquired from an imaging device, such as a camera, installed at or near an intersection for the purpose of monitoring traffic and other dynamic objects.

The term “moving object” refers to any entity, such as a vehicle or pedestrian, that is traveling through or near an intersection and can be detected by an imaging device.

The term “traffic volume” refers to the number or density of moving objects, including vehicles and pedestrians, passing through an intersection during a specific period of time.

The term “user's emotional state” refers to the psychological or affective condition of a person, such as stress, anxiety, urgency, or calmness, as determined by analyzing data from emotion recognition sensors or devices.

The term “predetermined threshold” refers to a set value or criterion, defined in advance, for parameters such as traffic volume or emotional state, which is used as a reference to determine whether a specific system action, such as changing a traffic signal, should be taken.

The term “traffic control signal” refers to an electronic signal device, such as a traffic light, that is used to control the flow of vehicles and pedestrians through an intersection by indicating stop, caution, or go instructions.

The term “information presentation device” refers to any output unit, including but not limited to smart glasses, display panels, or mobile terminals, that provides real-time information or notifications to users regarding the state and changes of the traffic control signal.

The term “instruction sentence” refers to a natural language or machine-readable command generated by the system for input into a generative information processing apparatus, such as a generative AI model.

The term “generative information processing apparatus” refers to a system or device, including software or hardware, capable of generating data, solutions, or content in response to input instructions using artificial intelligence models or other generative algorithms.

The present invention can be embodied in the form of a traffic control system including a server, various terminals (such as imaging devices and emotion recognition sensors), and information presentation devices (such as smart glasses or vehicle-mounted displays).

The server may be a general-purpose computing device or a dedicated control server equipped with a processor, memory, storage, and network interfaces. The server operates by receiving real-time image information from cameras installed at intersections and emotion status data from emotion recognition sensors associated with users (for example, drivers or pedestrians).

The cameras can be general digital cameras or network cameras equipped with real-time streaming functionality, such as generic dome-type IP cameras. The emotion recognition sensors may consist of vision-based recognition systems, such as generic smart glasses with built-in image sensors, or stand-alone wearable emotion detection devices.
The server utilizes software modules such as video analysis applications (for example, computer vision libraries based on frameworks like OpenCV or deep learning platforms such as generic neural network-based object detection models) and emotion recognition engines (such as general-purpose emotion classification algorithms or commercially available emotion analysis APIs). The server processes the incoming image stream to extract and analyze features such as the presence, type, and movement of moving objects-vehicles or pedestrians-at the intersection. In parallel, the server processes the user's facial image data or behavioral data to determine the emotional state by means of the emotion recognition engine.
The processed information—traffic volume and emotional state—is compared against predetermined thresholds stored in the server's memory. When the server detects that the traffic volume is below a certain threshold or the user's emotional state exceeds a predetermined critical level (for example, indicating a high level of anxiety or stress), the server generates and sends a command to change the state of the intersection's traffic control signal. The signal control device may be a generic programmable controller installed at the intersection and connected to the server via a secure wired network.

Once the state of the traffic control signal has been changed, the server confirms the success of the operation by retrieving the response from the signal control device and verifying the new signal status. The server then records both the updated state of the traffic control signal and the reason for the change in a general-purpose log management system or cloud-based storage. At the same time, the server communicates the updated signal state and change reason to the user via an information presentation device, such as a generic smart glasses display or a vehicle's dashboard notification system.

Additionally, the server may be configured to generate an instruction sentence for a generative information processing apparatus, such as a generative AI model. This instruction (prompt sentence) can be used, for example, in system diagnostics, user queries, or automatic report generation.

As a specific example, consider the scenario where a user is driving an automated vehicle and is feeling anxious when approaching an intersection. The emotion recognition sensor detects the user's high anxiety and sends this data to the server along with the real-time intersection image. The server determines that the detected emotional state crosses the predetermined threshold, and that the current traffic volume is low. The server immediately commands the traffic signal to turn green, allowing the vehicle to pass safely and efficiently. Simultaneously, the server displays the notification “The light turned green early because you seemed stressed” to the user via smart glasses, and records the full event details for later analysis.

For reference, an example of a suitable prompt sentence for the generative AI model may be:

“Please describe how the intersection traffic signal system should instruct a signal change when a user is detected as feeling anxious.”

Through this configuration, the system achieves enhanced intersection safety and traffic flow by flexibly responding to both objective traffic data and the subjective emotional state of users, using general-purpose or commercially available hardware and software components.

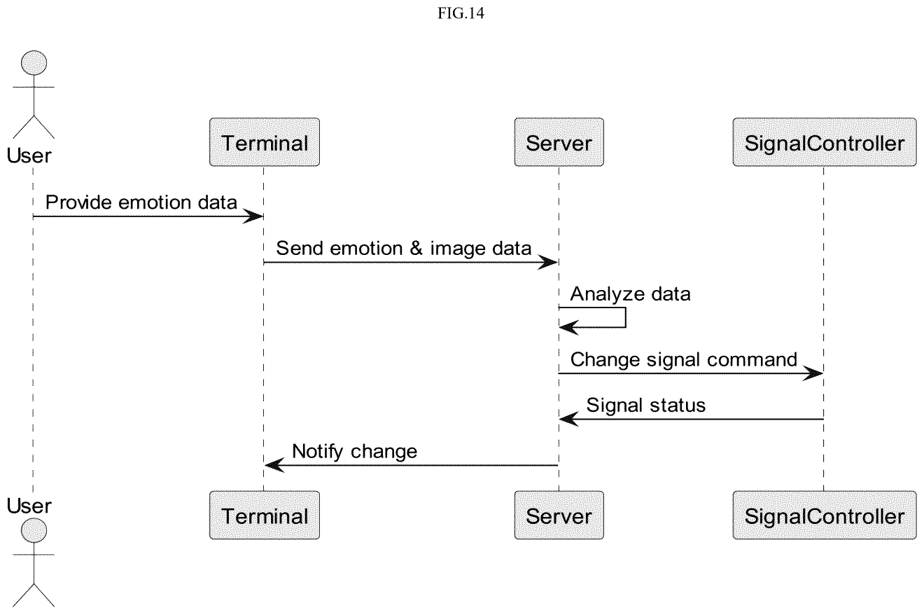

The following describes the processing flow using FIG. 14.

### Step 1:

The server acquires real-time image data from cameras installed at the intersection and receives emotion status data from emotion recognition sensors attached to terminals such as smart glasses or wearable devices. Input for this step includes live video streams and emotion sensor readings. The server sends acquisition requests via a network protocol and temporarily stores the received image frames and emotion data in the system memory. Output is the collection of image data and emotion data available for further processing.

### Step 2:

The server analyzes the acquired image data using a video analysis module based on computer vision algorithms and deep learning object detection models. Input is the real-time image data from Step 1. The server performs frame extraction, applies object detection, and identifies types, positions, and movements of moving objects such as vehicles and pedestrians. Output is a list of detected objects with parameters including location, direction, and speed.

### Step 3:

The server analyzes the emotion data using an emotion recognition engine. Input is the emotion data collected from terminals in Step 1. The server processes the data, classifies it using predefined emotional categories (such as anxiety or neutrality), and determines a user emotion score. Output is the user's emotional state and a quantitative emotion score.

### Step 4:

The server evaluates the traffic situation and user's emotional state based on the detected object information and emotion score. Input is the traffic data from Step 2 and emotion score from Step 3. The server compares the number of detected moving objects with historical and threshold values, and compares the emotion score to a predefined threshold. Output is a decision on whether to change the traffic signal, along with the reasoning (e.g., “low traffic volume” or “user anxiety detected”).

### Step 5:

If the server determines that a signal change is necessary, it sends a command to the traffic signal control device to change the signal (for example, from red to green). Input is the signal change decision from Step 4. The server formats the command, transmits it to the programmable signal controller, and records the transmission. Output is a confirmation request waiting for a response from the controller.

### Step 6:

The server confirms the new traffic signal state by receiving a response from the signal control device. Input is the reply or status message from the controller. The server checks if the signal has successfully changed to the desired state. Output is a verified status of the current traffic signal.

### Step 7:

The server records in the log database the changed signal state, the time of the change, and the reason for the signal change. Input is the confirmed traffic signal status from Step 6 and the reasoning generated in Step 4. The server writes a structured entry in persistent storage for audit and analysis purposes. Output is an updated event log.

### Step 8:

The server sends the changed signal status and the reason for the change to information presentation terminals, such as smart glasses or vehicles' displays. Input is the signal state and reason from Steps 6 and 4. The terminal receives the data and displays a notification to the user (for example, “The light turned green early due to detected user anxiety”). Output is a visible notification to the user.

### Step 9:

The server generates an instruction sentence (prompt sentence) for a generative AI model based on the detected scenario and system actions. Input is the scenario details and action logs from previous steps. The server formats a descriptive instruction sentence for use with a generative information processing device. Output is a natural language prompt sentence, such as “Please describe how the intersection traffic signal system should instruct a signal change when a user is detected as feeling anxious.”

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

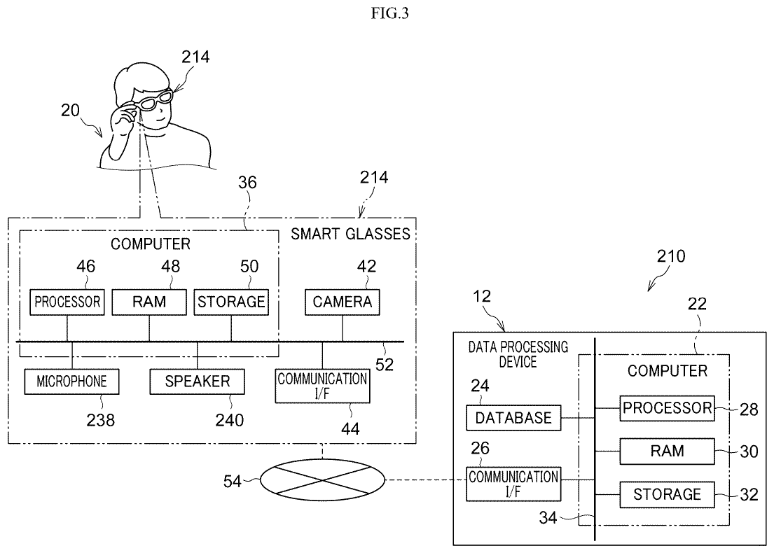

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

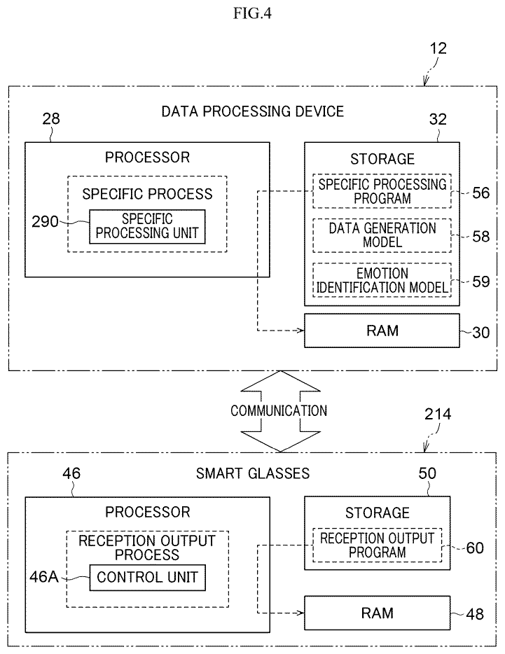

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

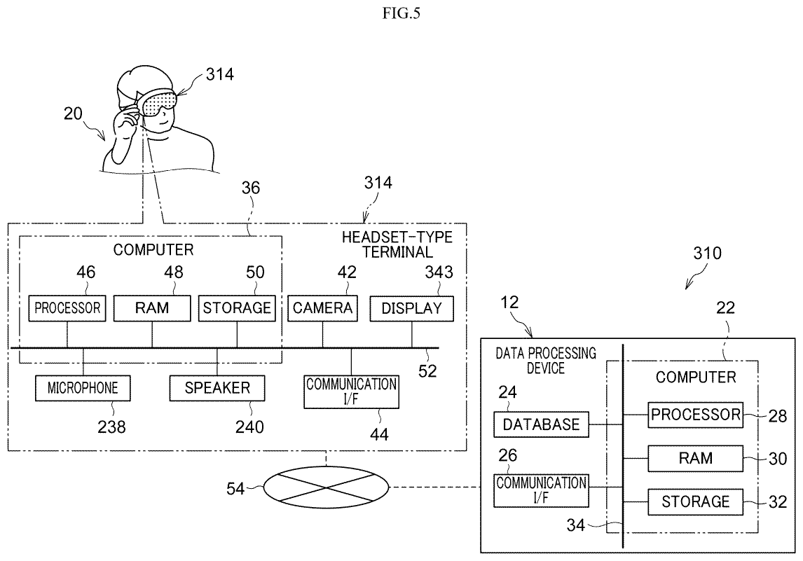

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

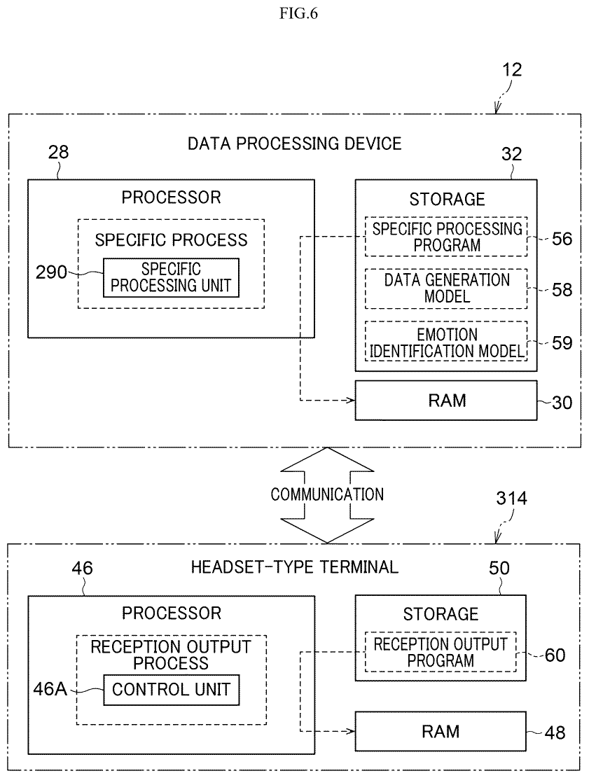

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

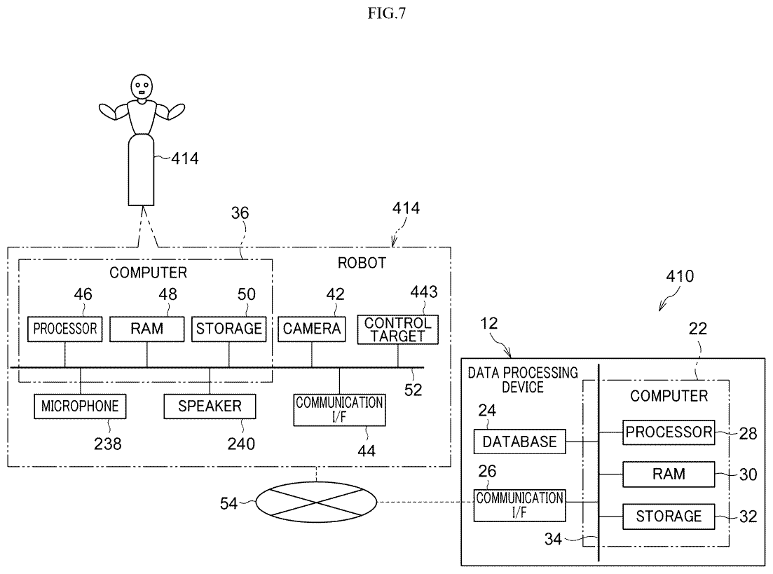

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

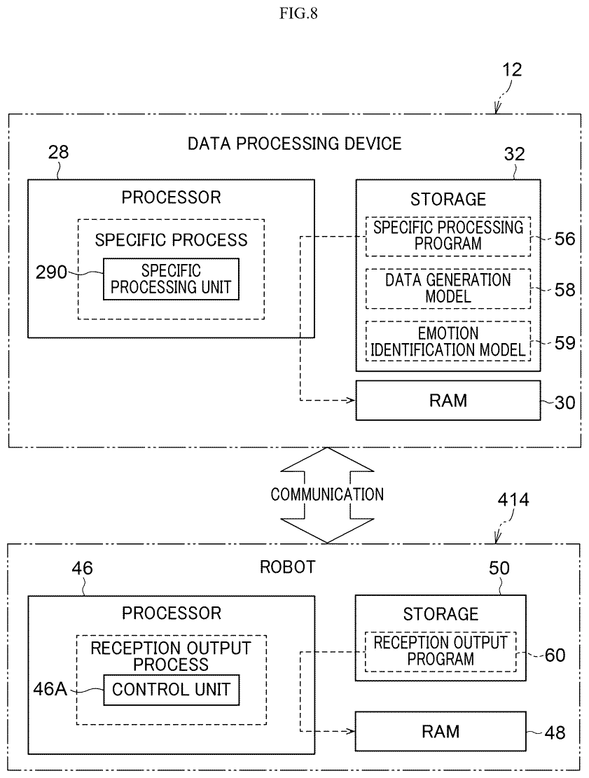

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

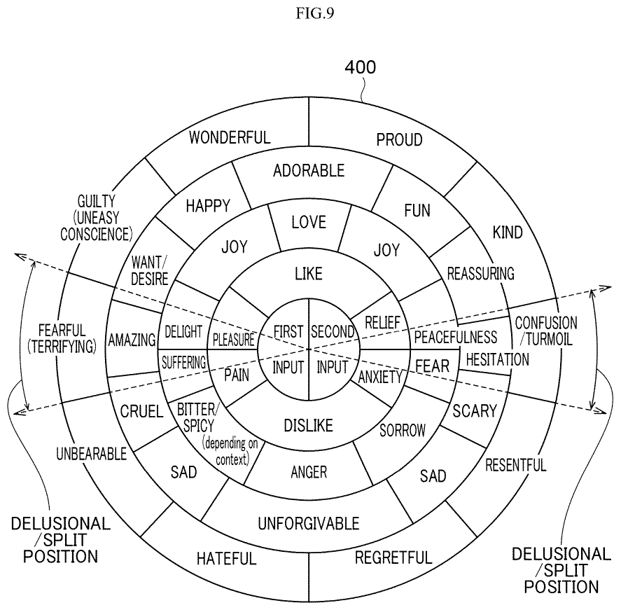

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more”and “want to know more”is experienced.

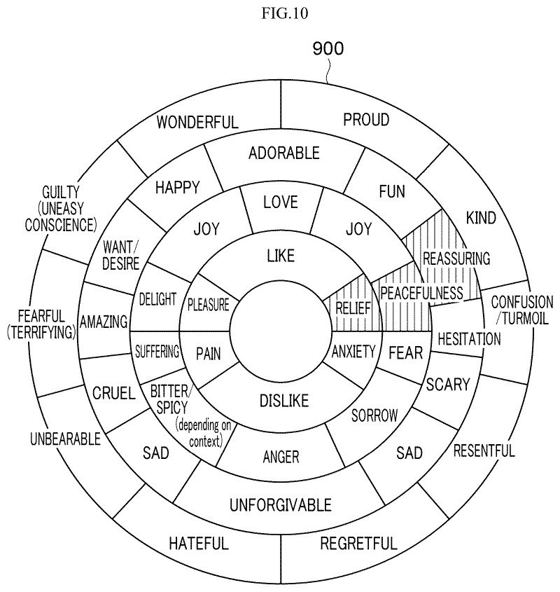

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system including a processor,
wherein the processor is configured to
acquire environmental information in real time from a monitoring device,
analyze the acquired environmental information to detect a moving object,
extract attribute information and motion information of the moving object using an image processing device,
calculate the number of moving objects within a predetermined region and determine a traffic volume based on the extracted attribute information and motion information,
transmit a control signal to a traffic control device to change a state when it is determined that the traffic volume is below a predetermined threshold,
acquire and verify the state of a control target after the change, and
record a process of change and a result in an information management device.

### (Supplementary 2)

The system according to supplementary 1,
wherein the processor is configured to
acquire a current state of the control target.

### (Supplementary 3)

The system according to supplementary 1,
wherein the processor is configured to
record state information after the change and information including a reason for the determination in an information recording device.

### Application Example 1

### (Supplementary 1)

A system including a processor,
wherein the processor is configured to
acquire image information of a space in real time from a motion information acquisition device,
analyze the acquired image information using image processing technology and a recognition model to identify target objects and extract the number and attribute information of the target objects,
evaluate the traffic volume of mobile bodies and pedestrians based on the extracted number of target objects,
output a control signal to a signal control device to change a signal when the evaluated traffic volume is below a set value,
confirm a change in the signal state based on state information obtained from the signal control device,
record the operational result and state change information in a storage device, provide mobile devices with signal state information and traffic status information via a communication function,
receive the signal state information and traffic status information at the mobile device and optimize a traveling route or traveling behavior,
acquire emotion information from a biosignal acquisition device and estimate an emotional state using an emotion recognition model, and
perform control of the signal state by the signal control device based on the traffic volume evaluation result and the emotional state.

### (Supplementary 2)

The system according to supplementary 1,
wherein the processor is configured to
acquire current state information from the signal control device.

### (Supplementary 3)

The system according to supplementary 1,
wherein the processor is configured to
record the signal state change, the traffic volume evaluation result, and the emotional state into a recording medium.

### Example 2

### (Supplementary 1)

A system including a processor,
wherein the processor is configured to
acquire spatial information in real time from an image information acquisition device,
analyze the acquired spatial information to detect moving objects,
analyze emotion state information from a biometric information acquisition device associated with the detected moving objects and identify emotion states,
determine traffic conditions and emotion states based on the number of detected moving objects and the emotion state information,
change the state of a controlled device when the traffic condition is determined to be below a predetermined threshold or when the emotion state is determined to be a predetermined state, and
confirm the state of the controlled device after the change.

### (Supplementary 2)

The system according to supplementary 1,
wherein the processor is configured to acquire a current state of the controlled device.

### (Supplementary 3)

The system according to supplementary 1,
wherein the processor is configured to record the changed state of the controlled device in a storage area.

### Application Example 2

### (Supplementary 1)

A system including a processor,
wherein the processor is configured to
acquire intersection image information in real time,
analyze the acquired image information to detect moving objects passing through the intersection,
determine a traffic volume at the intersection based on a detection result of the moving objects,
acquire a user's emotional state,
analyze the emotional state to determine whether the emotional state exceeds a predetermined threshold,
change a traffic control signal when the traffic volume is less than or equal to a predetermined threshold or when the emotional state exceeds the predetermined threshold, confirm a state of the traffic control signal after the change,
display the state of the changed traffic control signal and a reason for the change on an information presentation device, and
record the state of the changed traffic control signal and the reason for the change.

### (Supplementary 2)

The system according to supplementary 1,
wherein the processor is configured to
acquire a current state of the traffic control signal.

### (Supplementary 3)

The system according to supplementary 1,
wherein the processor is configured to
generate an instruction sentence for a generative information processing apparatus.

What is claimed is:

1. A system comprising a processor,
wherein the processor is configured to
acquire real-time video of an intersection,
analyze the acquired video to detect vehicles and pedestrians passing through the intersection,
determine a traffic volume based on the detection result,
change a traffic signal when the traffic volume is determined to be below a predetermined threshold, and
confirm a state of the traffic signal after the change.

2. The system according to claim 1, wherein the processor is configured to further acquire a current state of the traffic signal.

3. The system according to claim 1, wherein the processor is configured to further record a changed state of the traffic signal in a log.
